(19) United States
(12) Patent Application Publication
(10) Pub. No.: US 2020/0334779 A1
(43) Pub. Date: Oct. 22, 2020

(54) FRAUD GANG IDENTIFICATION METHOD AND DEVICE

(71) Applicant: ALIBABA GROUP HOLDING LIMITED, George Town (KY)

(72) Inventors: Changhua MENG, Hangzhou (CN); Kai XIAO, Hangzhou (CN); Lujia CHEN, Hangzhou (CN); Weiqiang WANG, Hangzhou (CN)

(21) Appl. No.: 16/917,635

(22) Filed: Jun. 30, 2020

Related U.S. Application Data
(63) Continuation of application No. PCT/CN2019/073652, filed on Jan. 29, 2019.

(30) Foreign Application Priority Data
May 4, 2018 (CN) 201810417935.8

(51) Int. Cl. G06Q 50/26; G06Q 30/00; G06Q 50/00; G06F 16/28

(52) U.S. Cl. CPC G06Q 50/265; G06F 16/285; G06Q 50/01; G06Q 30/0185

(57) ABSTRACT

Implementations of the present specification provide a fraud gang identification method and device. The method includes: constructing a relational network that includes a plurality of nodes; performing cluster discovery based on the relational network to obtain at least one fraud gang included in the relational network, each fraud gang including the plurality of nodes; determining a weak node from the nodes included in the fraud gang, the weak node being a node whose association with the fraud gang meets a weak association criterion; and removing the weak node from the fraud gang to identify a final target fraud gang.

### BACKGROUND

### Technical Field

The present disclosure relates to the field of Internet technologies, and in particular, to fraud gang identification methods and devices.

### Description of the Related Art

In recent years, Internet frauds have become increasingly arrogant, especially gang crimes. Fraudulent criminal gangs can use the Internet platform to attract victims, and commit frauds in various ways. Fraudsters can change identities and register new accounts, or use a plurality of identities and register different accounts, and distribute frauds to different accounts. Consequently, it becomes more difficult to identify fraudulent crimes by using an anti-fraud system. In this background, to effectively prevent and control frauds, a gang identification model for detecting criminal gangs can be developed based on a relational network, so that crime gangs can be identified and cracked down powerfully.

### BRIEF SUMMARY

One or more implementations of the present specification provide a fraud gang identification method and device to improve gang identification precision.

In particular, one or more implementations of the present specification are implemented by using the following technical solutions:

According to a first aspect, a fraud gang identification method is provided, including: constructing a relational network that includes a plurality of nodes; performing cluster discovery based on the relational network to obtain at least one fraud gang included in the relational network, each fraud gang including the plurality of nodes; determining a weak node from the nodes included in the fraud gang, the weak node being a node whose association with the fraud gang meets a weak association criterion; and removing the weak node from the fraud gang to identify a final target fraud gang.

According to a second aspect, a fraud gang identification device is provided, including: a network construction module, configured to construct a relational network that includes a plurality of nodes; a cluster processing module, configured to perform cluster discovery based on the relational network to obtain at least one fraud gang included in the relational network, each fraud gang including the plurality of nodes; a node determining module, configured to determine a weak node from the nodes included in the fraud gang, the weak node being a node whose association with the fraud gang meets a weak association criterion; and a pruning processing module, configured to remove the weak node from the fraud gang to identify a final target fraud gang.

According to a third aspect, a fraud gang identification device is provided, where the device includes a memory, a processor, and a computer instruction stored in the memory and executable by the processor, and the processor implements the following steps when executing the instruction: constructing a relational network that includes a plurality of nodes; performing cluster discovery based on the relational network to obtain at least one fraud gang included in the relational network, each fraud gang including the plurality of nodes; determining a weak node from the nodes included in the fraud gang, the weak node being a node whose association with the fraud gang meets a weak association criterion; and removing the weak node from the fraud gang to identify a final target fraud gang.

According to the fraud gang identification method and device provided in one or more implementations of the present specification, weak nodes are removed from the gang, that is, the nodes that are weakly associated with the gang are removed, the gang identification precision is increased, and the size of the identified gang is reduced, thereby improving the precision of gang identification.

### BRIEF DESCRIPTION OF THE SEVERAL VIEWS OF THE DRAWINGS

To describe the technical solutions in one or more implementations of the present specification or the prior art more clearly, the following briefly introduces the accompanying drawings for describing the implementations or the prior art. Clearly, the accompanying drawings in the following description are merely one or more implementations of the present specification, and a person of ordinary skill in the art can obtain other drawings based on the accompanying drawings without creative efforts.

FIG. 1 is a flowchart illustrating a fraud gang identification method according to one or more implementations of the present specification.

FIG. 2 is a schematic diagram illustrating a relational network according to one or more implementations of the present specification.

FIG. 3 is a schematic diagram illustrating removing a link edge from a gang according to one or more implementations of the present specification.

FIG. 4 is a schematic diagram illustrating removing a weak node from a gang according to one or more implementations of the present specification.

FIG. 5 is a schematic diagram illustrating removing a weak node from a gang according to one or more implementations of the present specification.

FIG. 6 is a schematic diagram illustrating gang subdivision according to one or more implementations of the present specification.

FIG. 7 is a structural diagram illustrating a fraud gang identification according to one or more implementations of the present specification.

FIG. 8 is a structural diagram illustrating a fraud gang identification according to one or more implementations of the present specification.

### DETAILED DESCRIPTION

To enable a person skilled in the art to better understand the technical solutions in one or more implementations of the present specification, the following clearly and completely describes the technical solutions in one or more implementations of the present specification with reference to the accompanying drawings in one or more implementations of the present specification. Clearly, the described implementations are merely some rather than all of the implementations of the present specification. Based on one or more implementations of the present specification, all other implementations obtained by a person of ordinary skill in the art without creative efforts shall fall within the scope of the present disclosure.

The specification includes techniques to identify a group of people or devices that are linked to one another in conducting internet-based activities. The internet-based activities may be organized together or associated with one another loosely under a common scheme. The activities and/or the group of people may be linked to one another vertically as upstream activities and downstream activities and/or horizontally as coordinators or team members. The activities of the group of people may be synchronized or random. The description herein uses internet-based fraud gangs as an illustrative example of such a group of people, which does not limit the scope of the specification. The techniques described herein, e.g., with respect to identifying internet-based fraud gangs, are also applicable to identify other internet-based groups or group activities, e.g., internet-based gaming group, internet-based charity group, internet-based exercising group, internet-based shopping group, internet-based marketing group, internet-based knowledge sharing group, etc., which are all included in the scope of the specification. The fraud gang identification method according to one or more implementations of the present specification can be applied to identify fraud gangs, for example, gangs that commit fraudulent crimes based on an Internet platform.

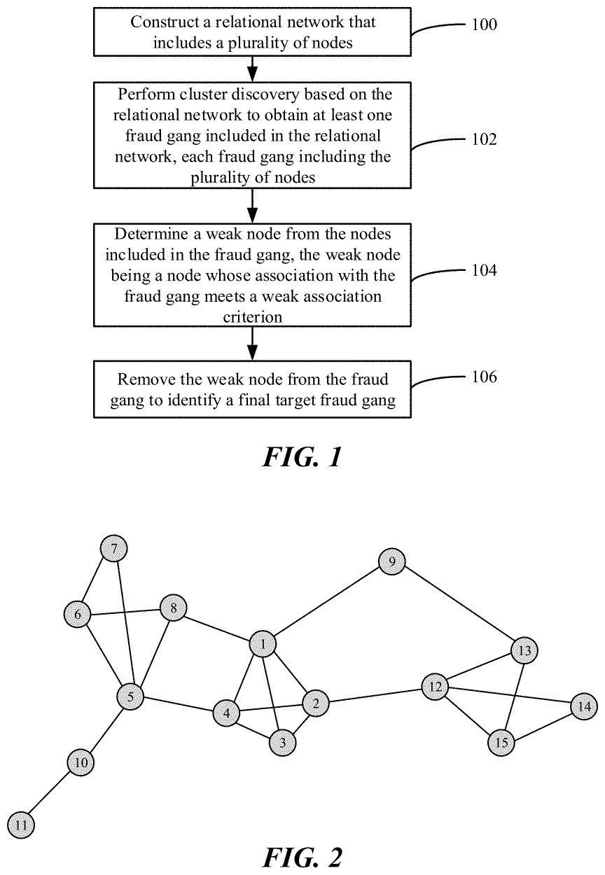

FIG. 1 is a flowchart illustrating a fraud gang identification method. The method can include the following steps.

Step 100: Construct a relational network that includes a plurality of nodes.

In this step, the nodes in the relational network can be, for example, user accounts, or user equipment, or can be other types of nodes. The node can be treated or serve as a criminal individual in a gang crime.

Using user accounts as an example, transfer accounts of different users can be used as nodes. If there is a medium shared between/among different nodes, those nodes are treated as linked. For example, the shared medium can be a common device, a fingerprint, a certificate number, an associated account, Wi-Fi, an LBS, or the like used between accounts in a transfer transaction. If there is at least one shared medium between two nodes, an edge can be connected between the two nodes, and the edge is referred to as a link edge between the nodes.

Referring to the example relational network shown in FIG. 2, the network can include 15 nodes, and there is a link edge between nodes that have a shared medium. These nodes and link edges form a relational network.

In addition, it is worthwhile to note that each node in the relational network can be a node with at least a fraud risk. For example, fraudulent transactions have occurred on some nodes, and such nodes are confirmed as fraud nodes; and some nodes have shared a medium with the nodes that have been confirmed as fraud nodes, but no fraudulent transaction has been confirmed on these nodes, such nodes can be considered as nodes with a fraud risk/suspicion or suspected fraud nodes. In this example, a possible fraud gang can be detected in a relational network that includes confirmed fraud nodes or suspected fraud nodes. The relational network may be established based on predetermined activities conducted at the relevant nodes or may be based on dynamically determined activities that occur at the nodes involved in the activities. For example, shared medium between and/among nodes may be first detected to establish link edges between/among the nodes and the activities at the nodes that correspond to the shared medium may be determined after the link edge has been established. The link edges among nodes and the activities at the nodes may then be used to dynamically build or detect the relational network. The activities at the nodes may also be determined based on the established relational network. For example, a server may dynamically monitor the shared mediums between nodes to set up the link edges and may trace and determine the activities of the nodes following the link edges.

Step 102: Perform cluster discovery based on the relational network to obtain at least one fraud gang included in the relational network, each fraud gang including the plurality of nodes.

In this step, a fraud gang included in the network can be detected based on the established relational network.

For example, a propagation tag clustering algorithm can be used to perform community discovery, to detect a fraud gang included in the relational network. Using FIG. 2 as an example, it is found through clustering that nodes 1 to 11 can be grouped into one gang and nodes 12 to 15 can be grouped into another gang.

Detection of a gang indicates a relatively strong correlation between the nodes included in the gang, for example, the nodes have shared a large number of shared media, or many transfer transactions have occurred on the nodes.

Step 104: Determine a weak node from the nodes included in the fraud gang, the weak node being a node whose association with the fraud gang meets a weak association criterion.

For example, in some embodiments, each node in the fraud gang is rated based on the link edges of the nodes with other nodes in the fraud gang. The rating indicates the association between the node and other nodes, and thus the fraud gang. A node having a stronger associate with other nodes, thus the fraud gang, is rated with a higher rating value; and a node having a weaker association with other nodes, thus the fraud gang, is rated with a lower rating value. For example, a “weak association criterion” can be used to define weak nodes. For example, a node with a rating that meets the weak association criterion is determined as a weak node. The criterion can be determined or adjusted based on the actual scenario of the fraud identification implementation or operation. Two examples of weak nodes are provided below, but the actual implementation is not limited thereto.

In an example, the “weak association criterion” can be that “the number of link edges to other nodes in a fraud gang is less than a predetermined edge number threshold”. Based on this criterion, in a gang detected in the relational network, if the number of link edges between one node and other nodes in the fraud gang is less than the predetermined edge number threshold, it can be determined that the node is a weak node meeting the weak association criterion.

Still referring to the example in FIG. 2, there is only one link edge between node 11 and the gang in which node 11 is located, that is edge “11-10”. Assuming that the edge number threshold is 1 and that the node whose link edge number is less than or equal to 1 is regarded as a weak node, then node 11 meets the weak association criterion. It can be determined that node 11 is a weak node.

In another example, the “weak association criterion” can be that “an edge weight of link edges to other nodes in a fraud gang is less than a predetermined weight threshold”. Based on this criterion, in a gang detected in the relational network, if an edge weight, for example, the edge weight can be an average weight value or the sum of a plurality of weight values, of link edges between one node and other nodes in the fraud gang is less than the predetermined weight threshold, it can be determined that the node is a weak node meeting the weak association criterion.

Still using FIG. 2 as an example, even if a node has a plurality of link edges to other nodes in the gang, the edge weights of the plurality of link edges are lower than a predetermined weight threshold value, and are confirmed as weak nodes. For example, a link edge exists between node 6 and each of node 7, node 8, and node 5, and each link edge can have a corresponding edge weight, which can be comprehensively determined based on factors such as the number of shared media among the nodes and the number of transfer transactions. The edge weight of one link edge can be used to measure an interaction frequency, an association strength, etc., between the two nodes corresponding to the link edge. For example, the edge weights of the three link edges of node 6 can be averaged or summed, and the averaged or summed value can be referred to as the edge weight corresponding to node 6. If an edge weight corresponding to a node is lower than a predetermined weight threshold, it can be considered that the node meets a weak association criterion, and the node can be confirmed as a weak node.

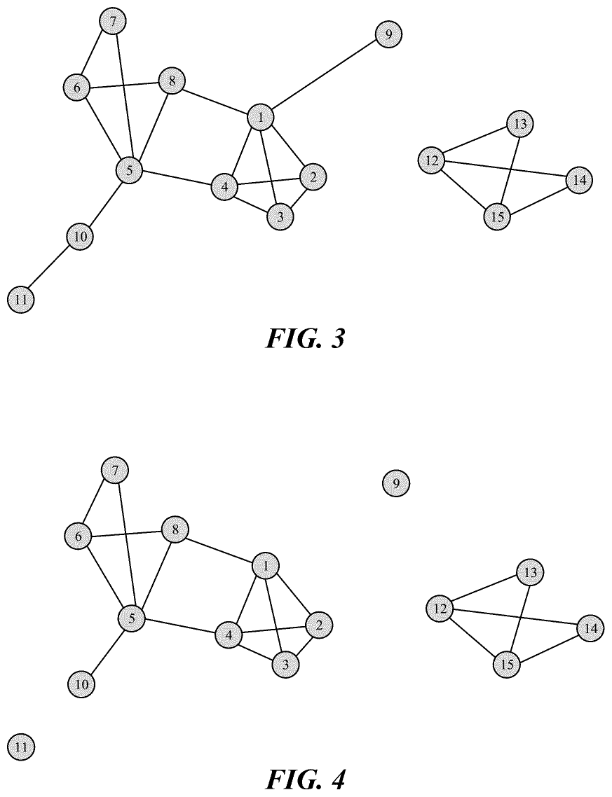

In addition, before a weak node is confirmed, the gang link edge between the gangs can be removed from at least one fraud gang detected in the relational network. For example, in FIG. 2, assuming that nodes 1 to 11 can be grouped into one gang, and nodes 12 to 15 can be grouped into another gang, then the link edge between node 9 and node 13, which can be referred to as a gang link edge, that is, the two nodes connected by the gang link edge belong to different gangs, can be removed, and the link edge between node 2 and node 12 can be removed. Referring to the example in FIG. 3, two separate gangs are obtained after the gang link edges are removed.

Step 106: Remove the weak node from the fraud gang to identify a final target fraud gang.

In this step, weak nodes determined in step 104 are removed from each gang. In addition, the weak nodes can be removed in an iterative manner.

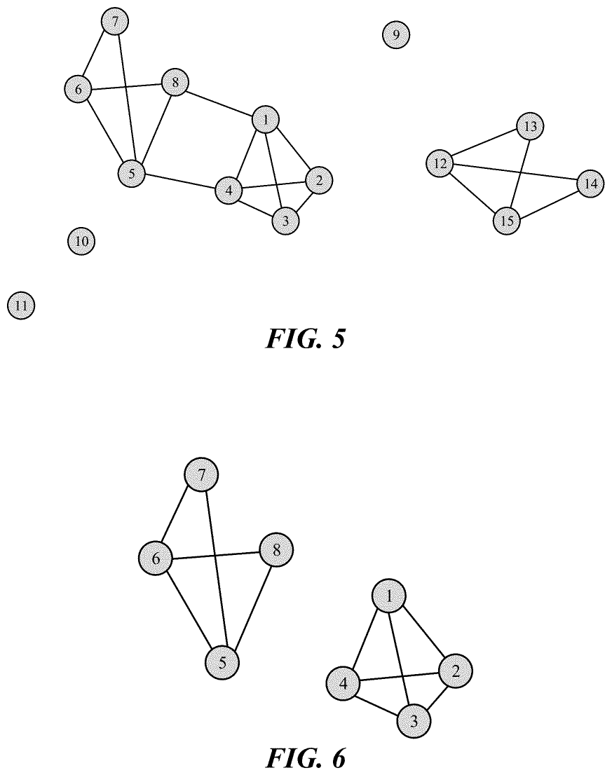

For example, referring to the examples in FIG. 4 and FIG. 5, in FIG. 4, the link edge between node 9 and node 1 can be removed based on the weak association criterion, which is equivalent to removing node 9 from the gang; and the link edge between node 11 and node 10 is also removed, which is equivalent to removing node 11 from the gang. Next, in FIG. 5, the determination is continued based on the weak association criterion, and node 10 is determined as a weak node, because node 10 also has only one link edge. After the node 10 is removed, the link edge between node 10 and node 5 can be removed in FIG. 5. After node 9, node 11, and node 10 have been removed, each of the remaining nodes has more than one link edge, and therefore is not a weak node.

In addition, in the above method of removing weak nodes in an iterative manner, all weak nodes in each fraud gang can be removed. In actual implementations, it is also possible that only some of the weak nodes are removed. For example, in FIG. 4, node 11 and node 9 can be removed, but node 10 can be retained. To some extent, the removal of some weak nodes can also improve the precision of the gang identification. Specifically, how many weak nodes are removed can be determined based on the scenario of fraud gang identification operation. For example, an upper limit of the number of weak nodes to be removed can be predetermined or dynamically determined.

According to the fraud gang identification method in this example, the weak nodes are removed from the gang, that is, the nodes that are weakly associated are removed from the gang, so that the precision of the gang identification is optimized, and the size of the gang is also optimized, which helps to improve the precision of the gang identification.

In addition, after the weak nodes are removed from the fraud gang, if the fraud gang meets the gang subdivision criterion, cluster discovery can be continued on the fraud gang, that is, the gang can be subdivided.

For example, the gang subdivision criteria include, but are not limited to, the two criteria listed below, which can be considered separately or together:

if the number of nodes included in the fraud gang is greater than a node number threshold, the fraud gang needs to be subdivided; or

if the fraud case concentration value of the fraud gang is lower than a predetermined or dynamically determined case concentration threshold, the fraud gang needs to be subdivided.

The fraud case concentration value can be, for example, a ratio between the number of fraudulent transactions executed by the nodes in the gang to the total number of transactions of the gang.

In FIG. 5, assuming that after the weak nodes are removed, the number of nodes of the gang of node 1 to node 8 still relatively large, and the number of nodes is greater than the node number threshold, then the propagation tag clustering algorithm can be used to perform gang subdivision. A weak node can be removed after the subdivision. For example, after the subdivision, the gang of node 1 to node 8 can be divided into two gangs: one gang includes node 1 to node 4, and the other gang includes node 5 to node 8, as shown in FIG. 6.

Through continuous optimization of the gang identification, the finally identified gang can be referred to as the target fraud gang. The target fraud gang is identified with a good precision. Parameters such as association strength and fraud case concentration value of the target fraud gang can be calculated and pushed to an anti-fraud strategy team, thereby improving the precision of gang crackdown.

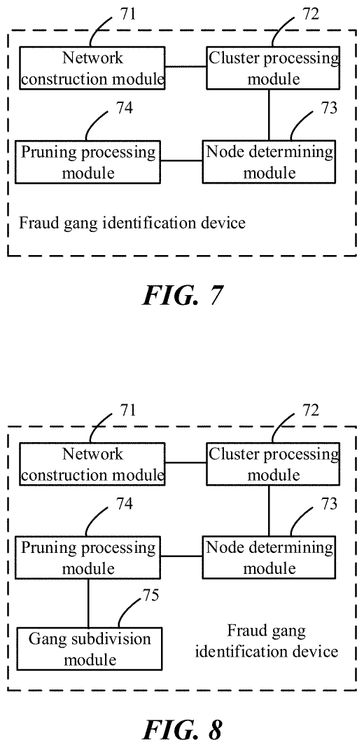

To implement the above fraud gang identification method, one or more implementations of the present specification provide a fraud gang identification device. As shown in FIG. 7, the device can include a network construction module 71, a cluster processing module 72, a node determining module 73, and a pruning processing module 74.

The network construction module 71 is configured to construct a relational network that includes a plurality of nodes.

The cluster processing module 72 is configured to perform cluster discovery based on the relational network to obtain at least one fraud gang included in the relational network, each fraud gang including the plurality of nodes.

The node determining module 73 is configured to determine a weak node from the nodes included in the fraud gang, the weak node being a node whose association with the fraud gang meets a weak association criterion.

The pruning processing module 74 is configured to remove the weak node from the fraud gang to identify a final target fraud gang.

In an example, the node determining module 73 is specifically configured to: if the number of link edges between a node and other nodes in a fraud gang is less than a predetermined edge number threshold, determine that the node is a weak node meeting a weak association criterion; or if an edge weight of a link edge between a node and another node in the fraud gang is lower than a predetermined weight threshold, determine that the node is a weak node meeting a weak association criterion.

In an example, as shown in FIG. 8, the device can further include a gang subdivision module 75, configured to continue to perform cluster discovery on the fraud gang if the fraud gang meets the gang subdivision criterion after the pruning processing module has removed the weak node from the fraud gang.

The devices or modules illustrated in the above implementations can be implemented by computer chips, entities, or products having a certain function. A typical implementation device is a computer in the form of a personal computer, a laptop computer, a cellular phone, a camera phone, a smart phone, a personal digital assistant, a media player, a navigation device, an e-mail transceiver, a game console, a tablet computer, a wearable device, or any combination of at least two of these devices.

For ease of description, the above device is described by dividing functions into various modules. Of course, during implementation of one or more implementations of the present specification, the functions of each module can be implemented in at least one of software or hardware.

The execution sequence of the steps in the process shown in the above figure is not limited to the sequence in the flowchart. In addition, the description of each step can be implemented in the form of software, hardware, or a combination of the software and the hardware. For example, a person skilled in the art can present the description of each step in the form of software code, namely computer executable instructions capable of implementing logical functions corresponding to the steps. When implemented in a software method, the executable instructions can be stored in a memory and executed by a processor in the device.

For example, corresponding to the above methods, one or more implementations of the present specification provide a fraud gang identification device. The device can include a processor, a memory, and a computer instruction that is stored in the memory and can run on the processor, and the processor executes the instruction to implement the following steps: constructing a relational network that includes a plurality of nodes; performing cluster discovery based on the relational network to obtain at least one fraud gang included in the relational network, each fraud gang including the plurality of nodes; determining a weak node from the nodes included in the fraud gang, the weak node being a node whose association with the fraud gang meets a weak association criterion; and removing the weak node from the fraud gang to identify a final target fraud gang.

It is also worthwhile to note that terms “include”, “comprise” or any other variant is intended to cover non-exclusive inclusion, so that processes, methods, commodities or devices that include a series of elements include not only those elements but also other elements that are not explicitly listed, or elements inherent in such processes, methods, commodities or devices. An element described by “includes a . . . ” further includes, without more constraints, another identical element in the process, method, product, or device that includes the element.

A person skilled in the art should understand that one or more implementations of the present specification can be provided as a method, a system, or a computer program product. Therefore, one or more implementations of the present specification can use a form of hardware only implementations, software only implementation, or implementations with a combination of software and hardware. In addition, one or more implementations of the present specification can use a form of a computer program product that is implemented on one or more computer-usable storage media (including but not limited to a disk memory, a CD-ROM, an optical memory, etc.) that include computer-usable program code.

One or more implementations of the present specification can be described in the general context of computer-executable instructions, for example, a program module. Generally, the program module includes a routine, a program, an object, a component, a data structure, etc., executing a specific task or implementing a specific abstract data type. One or more implementations of the present specification can also be practiced in distributed computing environments where tasks are performed by remote processing devices connected through a communications network. In a distributed computing environment, the program module can be located in both local and remote computer storage media including storage devices.

The implementations of the present specification are described in a progressive way. For same or similar parts of the implementations, mutual references can be made to the implementations. Each implementation focuses on a difference from the other implementations. Particularly, a system implementation is basically similar to a method implementation, and therefore is described briefly. For related parts, references can be made to related descriptions in the method implementation.

Specific implementations of the present specification are described above. Other implementations fall within the scope of the appended claims. In some situations, the actions or steps described in the claims can be performed in an order different from the order in the implementation and the desired results can still be achieved. In addition, the process depicted in the accompanying drawings does not necessarily require a particular execution order to achieve the desired results. In some implementations, multi-tasking and parallel processing can be advantageous.

The above descriptions are merely preferred implementations of one or more implementations of the present specification, and are not intended to limit one or more implementations of the present specification. Any modification, equivalent replacement, improvement, etc., made without departing from the spirit and principles of one or more implementations of the present specification shall fall within the protection scope of one or more implementations of the present specification.

The various embodiments described above can be combined to provide further embodiments. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A fraud gang identification method, comprising:
constructing a relational network that includes a plurality of nodes;
performing cluster discovery based on the relational network to obtain at least one fraud gang included in the relational network, each fraud gang including nodes of the plurality of nodes;
determining a weak node from the nodes included in the fraud gang, the weak node being a node whose association with the fraud gang meets a weak association criterion; and
removing the weak node from the fraud gang to identify a final target fraud gang.

2. The method according to claim 1, wherein the determining the weak node from the nodes included in the fraud gang comprises:
if the number of link edges between a node and other nodes in the fraud gang is less than an edge number threshold, determining that the node is a weak node meeting a weak association criterion.

3. The method according to claim 1, wherein the determining a weak node from the nodes included in the fraud gang comprises:
if an edge weight of a link edge between a node and another node in the fraud gang is lower than a weight threshold, determining that the node is a weak node meeting a weak association criterion.

4. The method according to claim 1, wherein the removing the weak node from the fraud gang comprises:
removing a gang link edge between different gangs from at least one fraud gang; and
removing some or all weak nodes from each fraud gang.

5. The method of claim 1, further comprising:
after the removing the weak node from the fraud gang and before the identifying the final target fraud gang, performing cluster discovery on the fraud gang if the fraud gang meets a gang subdivision criterion after the weak node has been removed from the fraud gang.

6. The method according to claim 5, wherein the gang subdivision criterion comprises:
a number of nodes included in the fraud gang is greater than a node number threshold; or
a fraud case concentration value of the fraud gang is lower than a case concentration threshold.

7. The method of claim 1, wherein the constructing the relational network including determining a link edge between a first node and a second node of the plurality of nodes.

8. The method of claim 7, wherein the link edge is a shared medium between the first node and the second node.

9. The method of claim 8, wherein the shared medium is one or more of a device, a fingerprint, a certificate number, an account number, a Wi-Fi location, or a location-based service account.

10. The method of claim 3, wherein the edge weight is an average value of weights of all link edges between the node and other nodes of the fraud gang.

11. The method of claim 3, wherein the edge weight is a sum of weights of all link edges between the node and other nodes of the fraud gang.

12. The method of claim 3, wherein the edge weight is determined based on one or more of a number of shared media between the node and the other node or a number of transfer transactions between the node and the other node.

13. A device, comprising:
a network construction module, configured to construct a relational network that includes a plurality of nodes linked to one another through a plurality of link edges;
a cluster processing module, configured to perform cluster discovery based on the relational network to obtain at least one internet-based group included in the relational network, each internet-based group including nodes of the plurality of nodes;
a node determining module, configured to determine a weak node from the nodes included in the internet-based group, the weak node being a node whose association with other nodes of the internet-based group meets a weak association criterion; and
a pruning processing module, configured to remove the weak node from the internet-based group.

14. The device according to claim 13, wherein the node determining module is configured to:
if a number of link edges between a node and other nodes in the internet-based group is less than an edge number threshold, determine that the node is a weak node; or
if an edge weight of a link edge between a node and another node in the internet-based group is lower than a weight threshold, determine that the node is a weak node.

15. The device of claim 14, wherein the edge weight is determined based on one or more of a number of shared media between the node and the other node or a number of transfer transactions between the node and the other node.

16. The device of claim 14, wherein the edge weight is determined based on weights of all link edges between the node and the other nodes of the internet-based group.

17. The device according to claim 13, further comprising:
a subdivision module, configured to continue to perform cluster discovery on the internet-based group if the internet-based group meets a subdivision criterion after the pruning processing module has removed the weak node from the internet-based group.

18. The device of claim 13, wherein a link edge of the plurality of link edges is a shared medium between a first node and a second node of the plurality of nodes.

19. A system, comprising:
a memory;
a processor; and
computer instructions stored in the memory, which, when executed by the processor, configures the processor to implement acts including:
constructing a relational network that includes a plurality of nodes linked to one another through a plurality of link edges;
performing cluster discovery based on the relational network to obtain a cluster of nodes of the plurality of nodes included in the relational network;
determining a rating value of a node in the cluster of nodes based on a link edge between the node and another node in the cluster of nodes; and
removing a node from the cluster of node, which has a rating value that meets a threshold for removing a node.

20. The system according to claim 19, wherein the determining the rating value of the node in the cluster of nodes includes determining one or more of:
a number of link edges between the node and other nodes in the cluster of nodes; and
an edge weight of all link edge between the node and other nodes in the cluster of nodes.
